(19) United States
(12) Patent Application Publication
(10) Pub. No.: US 2004/0057446 A1
(43) Pub. Date: Mar. 25, 2004

(54) Method for enabling packet transfer delay compensation in multimedia streaming

(75) Inventors: Viktor Varsa, Irving, TX (US); Durhan Guerrero, Irving, TX (US); Ru-Shang Wang, Coppell, TX (US); Emre Baris Aksu, Tampere (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/623,133

(22) Filed: Jul. 16, 2003

Related U.S. Application Data
(60) Provisional application No. 60/396,920, filed on Jul. 16, 2002.

(51) Int. Cl. H04L 12/56

(52) U.S. Cl. 370/412

(57) ABSTRACT

A method and device for enabling packet transfer delay compensation in multimedia streaming. In order to enable a streaming server to optimally operate its rate-control and rate-shaping algorithms to compensate for packet transfer delay variation, information indicative of jitter buffering capabilities of the streaming client is conveyed to the streaming server. The information contains the client's chosen pre-decoding parameters so that the client's jitter buffering capabilities can be determined by the server based on the difference between the client's chosen pre-decoding parameters and the pre-decoding buffering parameters provided by the streaming server.

This application is based on and claims priority under 35 U.S.C. § 119(e) to U.S. provisional patent application Serial No. 60/396,920, filed Jul. 16, 2002.

### FIELD OF THE INVENTION

The present invention relates generally to multimedia streaming and, in particular, to the 3GPP Packet Switched Streaming Service (PSS).

### BACKGROUND OF THE INVENTION

The 3GPP (3rd Generation Partnership Project) Packet Switched Streaming Service (PSS) defines normative video buffering requirements, which are targeted to compensate for encoding and server-specific delay variation inherent in VBR (Variable Bit Rate) video compression and transmission (see 3GPP TS 26.234 V5.1.0, “Transparent End-to-End Packet Switched Streaming Service (PSS); Protocols and Codecs (Release 5)”, June 2002, hereafter referred to as TS 26.234; and Nokia, “PSS Buffering Requirements for Continuous Media” 3GPP TSG-SA WG4 Meeting #18 contribution S4-010497, September 2001). A similar normative “Video Buffering Verifier” is defined for MPEG-4 (see Annex D of ISO/IEC IS 14496-2, “Information Technology—Generic Coding of Audio-Visual Objects (MPEG-4), Part 2: Visual”, October 1998).

When both streaming server and client comply with the buffering requirements, it is guaranteed that the client is able to play out the stream transmitted by the server without client buffer violation (i.e. there will be no buffer underflow or overflow at the client) provided that the stream from the server is transmitted over a constant-delay, reliable transmission channel. In a real-time streaming system, however, the client also has to accommodate variable packet transfer delays and bit-rate variations on the transmission path. In general, packet transfer delay variation can be compensated for via jitter buffering at the streaming client.

The 3GPP standards define the Packet Switched Streaming Service as a transparent service over a 3G wireless network and do not specify any specific algorithms to be used by a client to deal with transport network impairments and/or characteristics. Thus, jitter buffering as a means for compensating for the packet transfer delay variation, is not included within the scope of the PSS video buffering requirements. PSS buffering requirements relate to the indicated “pre-decoder buffer” and the “post-decoder buffer” at the streaming client.

The variation of available bit-rate for packet transfer on a transmission path over time, such as bearer bit-rate variation on a 3G wireless radio access network, is the actual cause of packet transfer delay variation. Adaptation of the packet rate and media rate to the varying transmission path bit-rate conditions is usually carried out at the streaming server in order to maintain real-time packet transport (i.e. to avoid unnecessary pausing of playback due to pre-decoder buffer underflow). An example of such a rate adaptation system can be found in Haskell et al. (U.S. Pat. No. 5,565,924, “Encoder/Decoder Buffer Control for Variable Channel”).

The objective of rate adaptation is to guarantee the arrival of a sent packet before its play-out time. This play-out time is determined by the sampling time of the packet plus a given constant “end-to-end delay”. This end-to-end delay consists of a “server buffering delay”, a “transfer delay” (also known as “Channel buffer”) and a “client buffering delay”. It is the server's responsibility to estimate the transfer delay and choose packets for transmission that can reach the streaming client within the total end-to-end delay after being subject to a server buffering delay. During the session, the server should monitor the transfer delay and its variation and then adapt its own server buffering delay so that there are no client buffer violations. While the streaming client must comply with the normative buffering requirements of the service, it has the freedom to choose the maximum client buffering delay.

In PSS, the recommended parameters for client buffering are signaled from the streaming server to the streaming client using the Real Time Streaming Protocol (RTSP) (see IETF RFC2326 “Real Time Streaming Protocol (RTSP)”, April 1998). In MPEG-4 the buffering parameters are signaled as part of the video bitstream configuration information header. In selecting its rate control and/or rate shaping algorithms, the server assumes that the client will use exactly those parameters recommended by the server.

It should be noted that the recommended parameters are selected based on the assumption that packets are transmitted over a constant delay, reliable transmission channel. If the channel is not reliable or the delay is not constant and the client uses exactly the buffering parameters recommended by the server, play-out without client buffer violation cannot be guaranteed. In order to overcome this problem, a streaming client has to implement some additional jitter buffering. This jitter buffering is typically implemented in the same physical client buffer space as the pre-decoder buffering. This means that the additional jitter buffering is implemented by applying looser client buffering parameters than the pre-decoder buffering recommended by the streaming server. For example, the client can apply a longer initial client buffering delay and larger buffer size (capable of storing more bytes) than recommended for pre-decoder buffering. The client can also dynamically adjust the buffering parameters in an attempt to help compensate for packet transfer delays.

In the aforementioned US patent by Haskell et al., it is assumed that the server and client buffering parameters (i.e. buffer size and initial buffering delay) are known a-priori by both the server and the client, and no consideration is given to how this is accomplished.

In Clark et al. “RTCP Extensions for Voice over IP Metric Reporting”(IETF draft-clark-avt-rtcpvoip-01.txt), it is proposed that a so-called “end-system delay” parameter is transmitted in RTCP reports (i.e. defining an RTCP extension). Here the end-system delay is defined as the total encoding, decoding and jitter buffer delay determined at the reporting end point. This is defined as the time delay that would result from an arriving RTP frame being buffered, decoded, converted to “analog” form, being looped back at the local “analog” interface, encoded and made available for transmission as an RTP frame. In practice, using metric defined in this way in a multimedia streaming application seems impossible.

Instead of signaling the recommended parameters based on a constant delay reliable channel, the server may signal looser recommended pre-decoder buffering parameters to the client, to ensure that the client will in fact use looser buffering parameters instead of those actually required for a constant delay channel. In order to estimate how much looser parameters are to be signaled, the server considers such factors as the extra buffering delay and the buffer size that the client normally utilizes for packet transfer delay and channel rate variation compensation. However, the client does not know that the parameters signaled by the server have been adjusted already to include packet transfer delay compensation and may use even looser parameters for its buffering needs. This results in over-excessive buffering, as the extra client buffering is factored in twice: once by the server and once by the client.

There is a long-felt need for finding a solution where client buffering is optimally chosen and utilized through client-server collaboration in order to guarantee that the client buffer does not overflow or underflow. So far, this need has not been fulfilled.

### SUMMARY OF THE INVENTION

It is a primary object of the present invention to enable a streaming server to optimally operate its rate-control and rate-shaping algorithms in order to compensate for packet transfer delay variation by monitoring and controlling the distribution of the end-to-end delay for a given packet. Here, and in the following detailed description of the invention, the term “distribution of the end-to-end delay for a given packet” means the respective amounts of server buffering delay, transfer delay, jitter buffering delay and pre-decoding buffering delay that make up the end-to-end delay.

This object can be achieved by informing the streaming server about the buffering capabilities of the streaming client. Indication of the jitter buffering capabilities of the streaming client to the server is a new physical feature. In a multimedia streaming system, such indication of the jitter buffering capabilities of the streaming client to the streaming server can be used to assist the server's rate-control and/or rate-shaping algorithm that it applies for compensation of packet transfer delay and channel rate variations. For example, with knowledge of the client's maximum jitter buffering delay, the server can choose a rate-control algorithm that reduces the occurrence of client buffer violations.

Thus, according to the first aspect of the present invention, there is provided a client-server collaboration method for enabling packet transfer delay variation compensation in a multimedia streaming system, in which a signal indicative of pre-decoding buffering parameters is provided by a streaming server to a streaming client, and wherein the pre-decoding buffering parameters indicated by the server are chosen such as to ensure that the client is able to play out a packet stream without client buffer violation if the packet stream is transmitted over a constant delay, reliable channel. The method comprises the steps of:

determining client's chosen pre-decoding buffering parameters; and

providing information indicative of the client's chosen pre-decoding buffering parameters to the server, so that the client's jitter buffering capabilities can be determined based on a difference between the pre-decoding buffering parameters provided to the streaming server and the pre-decoding buffering parameters provided by the streaming server.

Advantageously, the pre-decoder buffer parameters provided by the server to the client are chosen based on the variable bit-rate characteristics of the transmitted packet stream and the buffering applied by the server.

Advantageously, the client provides the information indicative of the client's chosen buffering parameters to the server as soon as the client determines the pre-decoding buffering parameters chosen to be used for a particular streaming session.

Advantageously, the client provides the information indicative of the client's chosen buffering parameters to the server when starting a new streaming session.

Advantageously, the client is adapted to dynamically change its buffering parameters during a streaming session, and the method further comprises the step of providing further information indicative of the client's changed buffering parameters to the server during the streaming session.

Advantageously, the method further comprises the step of applying in the streaming server rate-control and/or rate shaping algorithms that utilize the information indicative of the client's chosen pre-decoding buffering parameters to compensate for packet transfer delay and channel rate variations.

Advantageously, the streaming server optionally considers the information indicative of the client's chosen buffering parameters in rate control and/ or rate shaping.

Preferably, the the information indicative of the client's chosen buffering parameters includes some or all of the following:

information regarding a size of the client's pre-decoder buffer,

information regarding a pre-decoder buffering period, and

information regarding a post-decoder buffering time.

Advantageously, the streaming client provides the information indicative of the client's chosen pre-decoding buffering parameters to the streaming server in an RTSP OPTIONS request message, in an RTSP PLAY request message, or in an RTSP PING request message.

Advantageously, the method further comprises the step of determining in the streaming client whether the streaming server supports the signaling of client buffering parameters.

In particular, the signaling of streaming client buffering parameters to the streaming server is carried out in the context of the TS 26.234 buffering verifier (see Annex G of TS 26.234).

According to the second aspect of the present invention, there is provided a streaming client device including at least one buffer. The client device comprises:

means for receiving a packet stream from a streaming server and storing the packet stream in the at least one buffer;

means for playing-out the packet stream; and

means for providing information indicative of the client's chosen buffering parameters to the streaming server.

Preferably, the at least one buffer comprises a pre-decoder buffer, a delay jitter buffer and a post-decoder buffer.

Advantageously, the pre-decoder buffer and delay jitter buffer are integrated as a single unit.

Advantageously, the streaming client device also has means for receiving an indication of pre-decoder buffering parameters chosen by the streaming server.

Advantageously, the client device is adapted to change its chosen buffering parameters dynamically during a streaming session, and wherein the providing means further providing information indicative of the client's changed buffering parameters to the server during the streaming session.

According to the third aspect of the present invention, there is provided a streaming server device, which comprises:

means for transmitting a packet stream to a streaming client device, and

means for receiving information indicative of chosen buffering parameters of the streaming client device.

Preferably, the streaming server device is adapted to provide a signal indicative of pre-decoding buffering parameters to the streaming client, wherein said pre-decoding buffering parameters indicated by the server are chosen such as to ensure that the client device is able to play out the packet stream without client buffer violation if the packet stream is transmitted over a constant delay, reliable channel.

Advantageously, the streaming server device is adapted to apply rate-control and/or rate shaping algorithms that utilize the information indicative of the client's chosen buffering parameters to compensate for packet transfer delay and channel rate variations occurring during transmission of said packet stream from the streaming server device to the streaming client device.

Advantageously, the streaming server device is adapted to optionally consider the information indicative of the client's chosen buffering parameters in rate control and/or rate shaping.

According to the fourth aspect of the present invention, a data streaming system, which comprises:

a streaming client device, and

a streaming server device, wherein the streaming client device comprises:

means for playing-out a packet stream provided by the streaming server device; and

means for providing information indicative of the client's chosen buffering parameters to the streaming server device, and wherein the streaming server device comprises

means for transmitting the packet stream to the streaming client device, and means for receiving the information indicative of the client's chosen buffering parameters.

### BRIEF DESCRIPTION OF THE DRAWINGS

FIG. 1 is a block diagram illustrating a multimedia streaming system according to the present invention.

FIG. 2 is a chart showing an example of delays in different buffers in the multimedia streaming system.

### BEST MODE FOR CARRYING OUT THE INVENTION

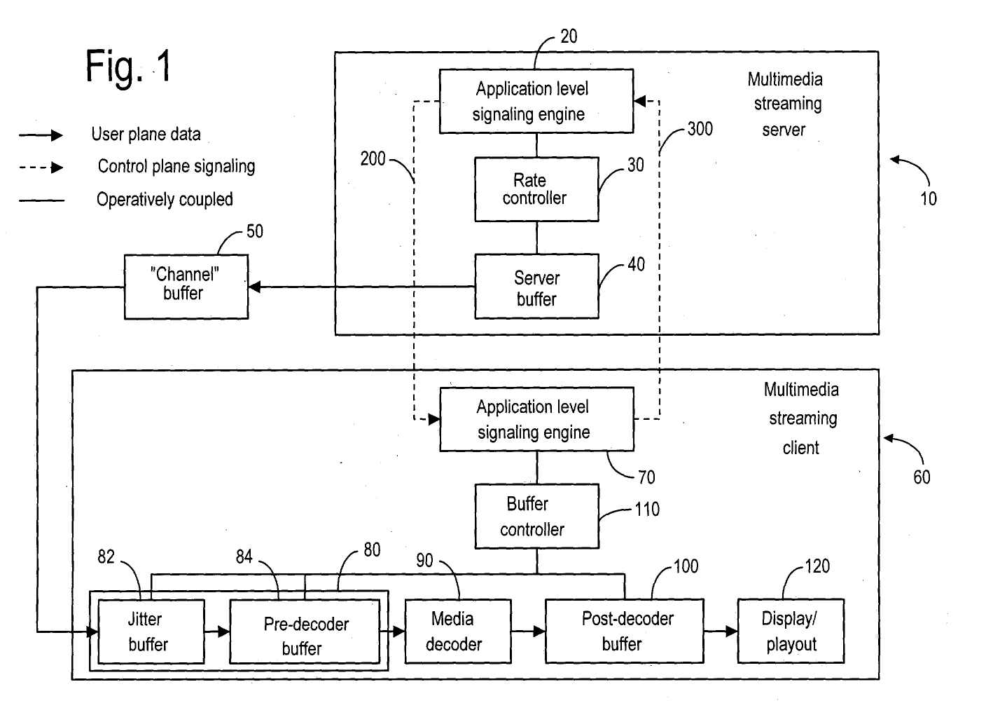

FIG. 1 is a block diagram illustrating a multimedia streaming system 1 according to the present invention, in which means are provided for signaling buffering parameters from a streaming client 60 to a streaming server 10.

The streaming server 10 comprises an application level signaling engine 20, a rate controller 30 and a server buffer 40. The streaming client 60 comprises an application level signaling engine 70, corresponding to, and adapted to communicate with, the application level signaling engine 20 in the streaming server 10. It further comprises a client buffer 80 which, in the embodiment of the invention illustrated in FIG. 1, comprises a jitter buffer 82 and a pre-decoding buffer 84, integrated as a single unit. In other embodiments of the invention, streaming client 60 may include a jitter buffer and a pre-decoding buffer that are implemented separately. The streaming client further comprises a media decoder 90, a post-decoder buffer 100, a buffer controller 110 and a display/play-out device 120.

The system depicted in FIG. 1 is further shown to comprise a “channel buffer” 50 located between streaming server 10 and streaming client 60. As. explained above in the background to the invention, this represents the varying transfer delay that occurs during transmission of data packets from the streaming server to the client.

The application level signaling engine 20 of the streaming server is adapted to transmit recommended buffering parameters to the streaming client, as denoted by reference numeral 200 in FIG. 1. In a preferred embodiment of the invention, implemented in accordance with the standards defining the 3rd Generation PSS service, these parameters, including, for example, an indication of an initial pre-decoder buffering time or pre-decoder buffer size, are transmitted from multimedia streaming server 10 to client 60 using the Real Time Streaming Protocol (RTSP). In alternative embodiments of the invention, implemented according to other specifications, such as MPEG-4, different mechanisms may be used.

The server's rate controller 30 is operative to adapt the rate at which media data is transmitted from the streaming server. It operates by adjusting the transmitted data rate in accordance with the varying bit-rate on the transmission channel, taking the client buffering parameters into account, thereby seeking to avoid pauses in play-back at the client due to pre-decoder buffer underflow.

Server buffer 40 stores data packets temporarily before they are transmitted from the streaming server across the transmission channel to streaming client 60. In a “live” streaming scenario where data packets are sampled real-time, the server buffer is indeed a physical buffer where data packets are placed at sampling time and are extracted at transmission time. In a “pre-encoded” streaming scenario, where data packets are not sampled real-time but are stored in a pre-encoded file and are read from the file at transmission time, the server buffer is a virtual buffer that represents the difference between sampling time (with reference to a sampling clock started at the streaming server when the first data packet of the pre-encoded file is transmitted) and transmission time of data packets.

At the streaming client, media data is received from the transmission channel and buffered in client buffer 80. The parameters of pre-decoder buffer 84 and jitter buffer 82 are set by the buffer controller 110. The parameters are chosen as an aggregate of the server recommended pre-decoder buffering parameters and the additional buffering estimated by the client. The client estimates what is needed to tolerate the expected packet transfer delay variation (i.e. jitter) on the available transmission channel. Such aggregate is constrained by the maximum buffering capabilities of the client. Media decoder 90 extracts media data from the client buffer and decodes the media data in a manner appropriate for media type in question. It should be appreciated that the media data will, in general, comprise a number of different media types. For example, if the media data transmitted from the server is representative of a video sequence, it is likely to comprise at least an audio component in addition to video data. It should therefore be understood that media decoder 90, as illustrated in FIG. 1, may actually comprise more than one decoder, for example a video decoder implemented according to a particular video coding standard and an associated audio decoder. As the media data is decoded by media decoder 90, it is output to post-decoder buffer 100 where it is stored temporarily until its scheduled play-out time, at which point it is passed from the post-decoder buffer to display/play-out device 120 under the control of buffer controller 110.

According to the invention, buffer controller 110 is adapted to provide an indication of the client's buffering parameters to application level signaling engine 70. The application level signaling engine is, in turn, adapted to transmit an indication of the client's buffering parameters to the streaming server, as denoted by reference numeral 300 in FIG. 1. In a preferred embodiment of the invention, the client's jitter buffering capabilities are only implicitly indicated to the streaming server as the difference between the signaled actual buffering parameters used by the client and the recommended pre-decoding buffering parameters provided by the streaming server. Preferably, this indication is provided by means of a signaling message transmitted from the application level signaling engine 70 in the streaming client over the transfer channel to the application level streaming engine 20 in the streaming server. In this way, a mechanism is provided for informing the streaming server about the buffering capabilities of the streaming client. This provides a number of significant technical advantages compared with systems in which no such indication is provided. In particular, if the streaming server 10 knows the actual client buffering parameters used during streaming, the server can apply rate-control and/or rate-shaping algorithms that utilize the actual client buffering parameters to compensate for packet transfer delay and channel rate variations. The present invention makes use of the combination of pre-decoder buffering and jitter buffering, and utilizes signaling of a single set of buffering parameters to indicate the packet transfer delay compensation capabilities of the client to the streaming server.

The streaming server 10, knowing that the client 60 will signal the actual buffering parameters that it chose to use, can initially signal the client the pre-decoder buffering parameters that are truly the recommended parameters for a constant-delay reliable channel. As such, the signaling of the pre-decoding buffering from the server to client will not be misused, thereby enabling the multimedia streaming server a more exact and explicit rate control.

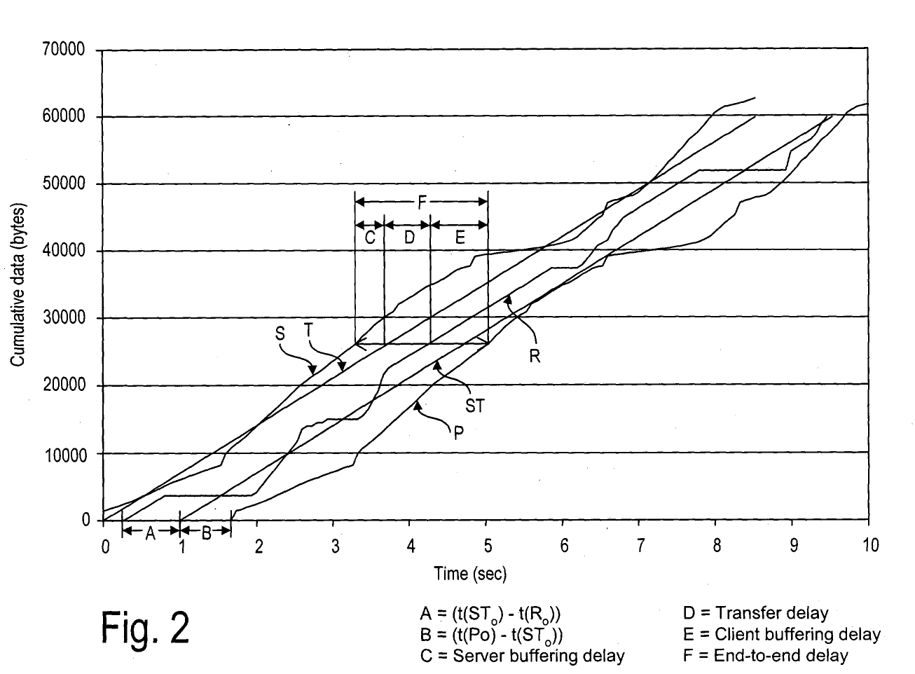

FIG. 2 illustrates example delays in the different buffers of the multimedia streaming system. In FIG. 2, the horizontal axis (x-axis) denotes time in seconds, and the vertical axis (y-axis) denotes cumulative amount of data in bytes. The sampling curve (S) indicates the progress of data generation as if the media encoder were running in real-time. The transmitter curve (T) shows the cumulative amount of data sent out by the server at a given time. (Notice that the straight line indicates constant bit-rate transmission.) The receiver curve (R) shows the cumulative amount of data received and placed into the client buffer at a given time, while the play-out curve (P) shows the cumulative amount of data which, at a given time, has been extracted from the pre-decoder buffer and processed by the decoder. The sampling curve (S) is the counterpart of the play-out curve (P) and is actually a time-shifted version of the play-out curve.

In FIG. 2, the delays in the different buffers can be readily seen. The “end-to-end” delay is represented by the x-axis difference between the sampling curve (S) and the play-out curve (P). The x-axis difference between the sampling curve (S) and the transmitter curve (T) indicates the “server buffering delay”. The varying “transfer delay” is represented by the x-axis difference between the receiver curve (R) and the transmitter curve (T), while the “client buffering delay” is indicated by the x-axis difference between the play-out curve (P) and the receiver curve (R). Thus, it should be appreciated that the “end-to-end delay”, represented by the x-axis difference between the play-out curve (P) and the sampling curve (S) is the sum of the “server buffering delay”, “transfer delay” and “client buffering delay”.

Viewing the graph along the cumulative data axis, the y-axis difference between the receiver curve (R) and play-out curve (P) shows the amount of data in the client buffer at a given time. The y-axis difference between the transmitter curve (T) and the receiver curve (R) is the amount of data which, at a given time, has been transmitted already, but not yet received at the receiver (streaming client).

The shifted transmitter (ST) curve shows the separation of pre-decoder buffering and jitter buffering at the streaming client. The x-axis difference between the play-out curve (P) and the shifted transmitter curve (ST) at zero cumulative data, denoted by (t(P₀)-t(ST₀)) in FIG. 2, shows the recommended initial pre-decoder buffering delay that is sufficient to be applied for decoding the transmitted stream over a constant delay channel. The x-axis difference between the shifted transmitter curve (ST) and receiver curve (R) at zero cumulative data, shown as (t(ST₀)-t(R₀)) in FIG. 2 is the initial jitter buffering delay that the client applies for compensation of packet transfer delay variation.

The fact that the receiver curve crosses the shifted transmitter curve several times without causing client buffer underflow indicates the usefulness of integrating the pre-decoder buffer delay with the jitter buffering delay, according to the present invention. It is assumed that the server is able to detect larger packet transfer delay variations through RTCP reports, and it can also apply rate-control and/or rate-shaping to compensate for them. In the example of FIG. 2, the server does not have to actually apply any correcting rate adaptation, as the client buffering is sufficient to correct the packet transfer delay variations. If the server were not aware of the client buffering parameters, it would have unnecessarily applied rate control and/or rate shaping.

Rules for Client Buffering Parameter Signaling

The signaling message containing the client buffering parameters can be sent any time, but it is most useful to be sent immediately whenever the client knows exactly the buffering parameters that it actually uses for a given streaming session. This signaling message is not a delay critical message or one that needs to be synchronized to the server time, because the client buffering parameters are usually constant for a longer period of time and they very seldom change. For example, there is usually only a need to signal new client buffering parameters after starting new media playback (i.e. after every new RTSP PLAY request).

If the streaming client dynamically changes any of the buffering parameters during playback (e.g., the client pauses and delays play-out for some time, thereby changing the initial buffering delay), it can send a new signaling message to the streaming server with the new buffering parameter values.

Implementation

The same RTSP extension parameters, as defined in TS 26.234 “Annex G.2 PSS Buffering Parameters” for the OK response message sent by the streaming server to a PLAY request, can be used to send the signaling message according to the present invention. The RTSP extension parameters, as defined in TS 26.234, are as follows:

x-predecbufsize:<size of the hypothetical pre-decoder buffer> (This gives the suggested size of the Annex G hypothetical pre-decoder buffer in bytes).

x-initpredecbufperiod:<initial pre-decoder buffering period> (This gives the required initial pre-decoder buffering period specified according to Annex G. Values are interpreted as clock ticks of a 90-kHz clock. That is, the value is incremented by one for each 1/90 000 seconds. For example, value 180 000 corresponds to a two-second initial pre-decoder buffering period).

x-initpostdecbufperiod:<initial post-decoder buffering period> (This gives the required initial post-decoder buffering period specified according to Annex G. Values are interpreted as clock ticks of a 90-kHz clock).

All or only some of these parameters can be included in a signaling message from the client to the server. It is also possible to define different parameters other than these parameters for the client-to-server signaling message.

The client can send these RTSP parameters in an RTSP OPTIONS request. As such, the server has to respond to such a request and reset the session timeout timer. Otherwise, such an OPTIONS request does not influence the server state.

For example, where the client signals that the actual initial client buffering period is half a second, in the request, the “initial pre-decoder buffering period” parameter is re-used (as shown in the example RTSP OPTIONS request and OK response message pair presented below):

C->S: OPTIONS *RTSP/1.0

CSeq: 833
Session: 12345678
x-initpredecbufperiod: 45000

S->C: RTSP/1.0 200 OK

CSeq: 833
Public: DESCRIBE, SETUP, TEARDOWN, PLAY, PAUSE

The client can also send these RTSP parameters in an empty RTSP PLAY request (i.e., without a “Range” header) from the streaming client to the streaming server while in an active PLAY state (i.e., not PAUSEd). The streaming server, according to IETF RFC2326, does not have to act on an empty PLAY request which is received while in an active PLAY state (i.e., if the server has not yet finished sending packets from the requested PLAY range), but care must be taken about possible misinterpretations, as such PLAY requests can also be queued, in which case they indicate that streaming is to be restarted as soon as the current PLAY range is over from the position where it stopped. The following example shows how an empty RTSP PLAY request can be used to signal pre-decoder buffering parameters according to the invention:

C->S: PLAY rtsp://audio.example.com/twister.en RTSP/1.0

CSeq: 833
Session: 12345678
x-initpredecbufperiod: 45000

S->C: RTSP/1.0 200 OK

CSeq: 833

The client could also send these RTSP parameters in an RTSP PING request.

If the server understands the client buffering parameter extensions, it should consider the signaled actual client buffering parameters in the currently active PLAY state (i.e., applying only to the last requested PLAY range within the streaming session).

It should be noted that the present invention is concerned with a streaming client and server collaborative algorithm. It is useful if both the client and the server implement the streaming collaborative algorithm. That is, if the client sends the buffering parameters at streaming time, the server actually utilizes this information in its rate control. Capability-exchange can be used to ensure that both the streaming server and the client support the signaling method. It should be noted that there are many possibilities to define a name for this feature. One of those possibilities is “client-buffering-parameters-signaling”, for example, and this name can be signaled in the first SETUP request as follows:

C->S: SETUP rtsp://audio.example.com/twister.en/video RTSP/1.0

CSeq: 3
Require: client-buffering-parameters-signaling

If the server does not support this feature, it MUST return an “unsupported” field as in the example:

S->C: RTSP/1.0 200 OK

CSeq: 3
Unsupported: client-buffering-parameters-signaling
<Other SETUP related params>

Once the client understands that it is not supported, it will not send such parameters in the OPTIONS request. If there is no “Unsupported” header, (which indicates that the server supports the feature), the client can safely signal client buffering parameters to the streaming server. The client can safely signal client buffering parameters (either in the OPTIONS request, PLAY request without range header or PING request) once the client understands that the feature is supported.

Although the invention has been described with respect to a preferred embodiment thereof, it will be understood by those skilled in the art that the foregoing and various other changes, omissions and deviations in the form and detail thereof may be made without departing from the scope of this invention.

What is claimed is:

1. A client-server collaboration method for enabling packet transfer delay variation compensation in a multimedia streaming system, in which a signal indicative of pre-decoding buffering parameters is provided by a streaming server to a streaming client, and wherein the pre-decoding buffering parameters indicated by the server are chosen such as to ensure that the client is able to play out a packet stream without client buffer violation if the packet stream is transmitted over a constant delay, reliable channel, said method comprising:
determining client's chosen pre-decoding buffering parameters; and
providing information indicative of the client's chosen pre-decoding buffering parameters to the server, so that the client's jitter buffering capabilities can be determined based on a difference between the pre-decoding buffering parameters provided to the streaming server and the pre-decoding buffering parameters provided by the streaming server.

2. A method according to claim 1, wherein the pre-decoder buffer parameters provided by the server to the client are chosen based on the variable bit-rate characteristics of the transmitted packet stream and the buffering applied by the server.

3. A method according to claim 1, wherein the client provides the information indicative of the client's chosen buffering parameters to the server as soon as the client determines the pre-decoding buffering parameters chosen to be used for a particular streaming session.

4. A method according to claim 1, wherein the client provides the information indicative of the client's chosen buffering parameters to the server when starting a new streaming session.

5. A method according to any of claim 1, wherein the client is adapted to dynamically change its buffering parameters during a streaming session, said method further comprising
providing further information indicative of the client's changed buffering parameters to the server during the streaming session.

6. A method according claim 1, further comprising
applying in the streaming server rate-control and/or rate shaping algorithms that utilize the information indicative of the client's chosen pre-decoding buffering parameters to compensate for packet transfer delay and channel rate variations.

7. A method according to claim 1, wherein the streaming server optionally considers the information indicative of the client's chosen buffering parameters in rate control and/ or rate shaping.

8. A method according to claim 1, wherein the information indicative of the client's chosen buffering parameters includes at least one of the following:
information regarding a size of the client's pre-decoder buffer,
information regarding a pre-decoder buffering period, and
information regarding a post-decoder buffering time.

9. A method according to claim 1, wherein the streaming client provides the information indicative of the client's chosen pre-decoding buffering parameters to the streaming server in an RTSP OPTIONS request message.

10. A method according to claim 1, wherein the streaming client provides the information indicative of the client's chosen pre-decoding buffering parameters to the streaming server in an RTSP PLAY request message.

11. A method according to claim 1, wherein the streaming client provides the information indicative of the client's chosen pre-decoding buffering parameters to the streaming server in an RTSP PING request message.

12. A method according to claim 1, further comprising
determining in the streaming client whether the streaming server supports the signaling of client buffering parameters.

13. A streaming client device including at least one buffer, comprising:
means for receiving a packet stream from a streaming server and storing the packet stream in the at least one buffer;
means for playing-out the packet stream; and
means for providing information indicative of the client's chosen buffering parameters to the streaming server.

14. A streaming client device according to claim 13, wherein said at least one buffer comprises a pre-decoder buffer and a delay jitter buffer.

15. A streaming client device according to claim 13, wherein said at least one buffer comprises a pre-decoder buffer, a delay jitter buffer and a post-decoder buffer.

16. A streaming client device according to claim 14, wherein the pre-decoder buffer and delay jitter buffer are integrated as a single unit.

17. A streaming client device according to claim 15, wherein the pre-decoder buffer and the delay jitter buffer are integrated as a single unit.

18. A streaming client device according to claim 13, further comprising
means for receiving an indication of pre-decoder buffering parameters chosen by the streaming server.

19. A streaming client device according to claim 13, wherein the client device provides the information indicative of the client's chosen buffering parameters to the server as soon as the client determines the buffering parameters chosen to be used for a particular streaming session.

20. A streaming client device according to claim 13, wherein the client device provides the information indicative of the client's chosen buffering parameters to the server when starting a new streaming session.

21. A streaming client device according claim 13, wherein the client device is adapted to change its chosen buffering parameters dynamically during a streaming session, and wherein said providing means further providing information indicative of the client's changed buffering parameters to the server during the streaming session.

22. A streaming client device according to claim 13, wherein the information indicative of the client's chosen buffering parameters includes at least one of the following:
information regarding a size of the client's pre-decoder buffer,
information regarding a pre-decoder buffering period, and
information regarding a post-decoder buffering time.

23. A streaming client device according to claim 13, wherein said providing means provides the information indicative of the client's chosen buffering parameters to the streaming server in an RTSP OPTIONS request message.

24. A streaming client device according to claim 13, wherein said providing means provides the information indicative of the client's chosen buffering parameters to the streaming server in an RTSP PLAY request message.

25. A streaming client device according claim 13, wherein said providing means provides the information indicative of the client's chosen buffering parameters to the streaming server in an RTSP PING request message.

26. A streaming client device according to claim 13, wherein the client device is adapted to determine whether the streaming server supports the signaling of client buffering parameters.

27. A streaming server device comprising:
means for transmitting a packet stream to a streaming client device, and
means for receiving information indicative of chosen buffering parameters of the streaming client device.

28. A streaming server device according to claim 27, adapted to provide a signal indicative of pre-decoding buffering parameters to the streaming client, wherein said pre-decoding buffering parameters indicated by the server are chosen such as to ensure that the client device is able to play out the packet stream without client buffer violation if the packet stream is transmitted over a constant delay, reliable channel.

29. A streaming server device according to claim 27, adapted to apply rate-control and/or rate shaping algorithms that utilize the information indicative of the client's chosen buffering parameters to compensate for packet transfer delay and channel rate variations occurring during transmission of said packet stream from the streaming server device to the streaming client device.

30. A streaming server device according to claim 27, adapted to optionally consider the information indicative of the client's chosen buffering parameters in rate control and/or rate shaping.

31. A streaming server device according to claim 27, wherein the information indicative of the client's buffering parameters received by the server includes at least one of the following:
information regarding a size of the client's pre-decoder buffer,
information regarding a pre-decoder buffering period, and
information regarding a post-decoder buffering time.

32. A data streaming system comprising:
a streaming client device, and
a streaming server device, wherein the streaming client device comprises:
means for playing-out a packet stream provided by the streaming server device; and
means for providing information indicative of the client's chosen buffering parameters to the streaming server device, and wherein the streaming server device comprises
means for transmitting the packet stream to the streaming client device, and
means for receiving the information indicative of the client's chosen buffering parameters.
